(19) United States
(12) Patent Application Publication
(10) Pub. No.: US 2013/0088750 A1
(43) Pub. Date: Apr. 11, 2013

(54) PRINTING APPARATUS AND PRINTING SYSTEM

(71) Applicant: Thanh NGUYENVAN, Nagoya-shi (JP)

(72) Inventor: Thanh NGUYENVAN, Nagoya-shi (JP)

(21) Appl. No.: 13/624,389

(22) Filed: Sep. 21, 2012

(30) Foreign Application Priority Data
Oct. 11, 2011 (JP) 2011-223778

(51) Int. Cl. G06F 3/12

(52) U.S. Cl. 358/1.15

(57) ABSTRACT

A printing apparatus including: a connecting unit connected to a management server; a receiving unit configured to receive a print instruction from the management server; a determining unit configured to determine whether there is another printing apparatus having a same name as a name of the printing apparatus among a printing apparatus connected to the management server in response to receiving the print instruction; an acquiring unit configured to acquire a print job; a printing unit configured to perform printing relative to the print job; an instructing unit configured to instruct start of the printing relative to the print job; and a print prohibiting unit configured to prohibit the printing relative to the print job from being performed until the instructing unit instructs the start of the printing if the determining unit determines that there is the other printing apparatus.

### CROSS-REFERENCE TO RELATED APPLICATIONS

This application claims priority from Japanese Patent Application No. 2011-223778 filed on Oct. 11, 2011, the entire contents of which are incorporated herein by reference.

### TECHNICAL FIELD

Aspects of the present invention relate to a printing apparatus which is connected to an information processing apparatus through a network, receives print data from the information processing apparatus through a print server, and prints the print data, and a printing system including the printing apparatus.

### BACKGROUND

There are printing systems in which one or more information processing apparatuses and printing apparatuses are connected through networks, and the printing apparatuses receive print data from the information processing apparatus through a print server and print the print data. In these systems, when a user uses the printing apparatus, the information processing apparatus queries a print server, and the print server allows printing on condition that an upper limit number of printing sheets is not exceeded (for example, see JP-A-2003-330686).

### SUMMARY

However, if there is a plurality of printing apparatuses capable of being designated from an information processing apparatus, there may be a plurality of printing apparatuses with the same name. Therefore, even if a user intends to use a particular printing apparatus, a print job may be input to and printed by another printing apparatus with the same name as that of the intended printing apparatus. In this case, the printed material may be left at the printing apparatus with the same name.

An object of the present invention is to provide a printing apparatus configured to prevent a printed material from being left an unintended printing apparatus among a plurality of printing apparatuses having the same name

According to an aspect of the present invention, there is provided a printing apparatus having a name, the printing apparatus including: a connecting unit connected to a management server; a receiving unit configured to receive a print instruction from the management server; a determining unit configured to determine whether there is another printing apparatus having a same name as the name of the printing apparatus among a printing apparatus connected to the management server in response to receiving the print instruction; an acquiring unit configured to acquire a print job that is instructed to be printed; a printing unit configured to perform printing relative to the print job acquired by the acquiring unit; an instructing unit configured to instruct start of the printing relative to the print job; and a print prohibiting unit configured to prohibit the printing relative to the print job acquired by the acquiring unit from being performed until the instructing unit instructs the start of the printing if the determining unit determines that there is the other printing apparatus having the same name.

In the printing apparatus, the print instruction is received and the printing relative to the print job that is instructed to be printed is performed. However, in a case where there is the other printing apparatus with the same name as that of the printing apparatus, the user may erroneously give a printing instruction between the printing apparatus and the other printing apparatus with the same name as that of the printing apparatus. For this reason, in the case where there is the other printing apparatus with the same name as that of the printing apparatus, printing relative to the print job is prohibited, such that printing relative to the print job cannot be performed unless there is a print instruction from the instructing unit.

According to this configuration, even if there is a plurality of printing apparatuses with the same name, it is possible to prevent printing from being performed by a printing apparatus unintended by the user and thus to prevent the printed material from being left at the unintended printing apparatus.

According to another aspect of the invention, there is provided a printing apparatus having a name, the printing apparatus including: a connecting unit connected to a management server; a receiving unit configured to receive a print instruction from the management server; a determining unit configured to determine whether there is another printing apparatus having a same name as the name of the printing apparatus in response to receiving the print instruction; an acquiring unit configured to acquire a print job that is instructed to be printed; a printing unit configured to perform printing relative to the print job acquired by the acquiring unit; an instructing unit configured to instruct start of the printing relative to the print job; and an acquisition prohibiting unit configured to prohibit the acquiring unit from acquiring the print job until the instructing unit instructs the start of the printing if the determining unit determines that there is the other printing apparatus having the same name.

According to another aspect of the invention, there is provided a printing system including a management server including a transmitting unit configured to transmit a print instruction and a printing apparatus having a name and including a receiving unit configured to receive the print instruction from the management server and a printing unit configured to perform printing relative to a print job, the management server and the printing apparatus being connected to a network, the printing system including: a determining unit configured to determine whether there is another printing apparatus having a same name as the name of the printing apparatus in response to receiving the print instruction; an acquiring unit configured to acquire the print job that is instructed to be printed; an instructing unit configured to instruct start of the printing relative to the print job; and a print prohibiting unit configured to prohibit the printing relative to the print job acquired by the acquiring unit from being performed until the instructing unit instructs the start of the printing if the determining unit determines that there is the other printing apparatus having the same name.

According to another aspect of the invention, there is provided a printing system in which a management server including a transmitting unit configured to transmit a print instruction and a printing apparatus having a name and including a receiving unit configured to receive the print instruction from the management server and a printing unit configured to perform printing relative to a print job, the management server and the printing apparatus being connected to a network, the printing system including: a determining unit configured to determine whether there is another printing apparatus having a same name as the name of the printing apparatus in response to receiving the print instruction; an acquiring unit configured to acquire the print job that is instructed to be printed; an instructing unit configured to instruct start of the printing relative to the print job; and an acquisition prohibiting unit configured to prohibit the acquiring unit from acquiring the print job until the instructing unit instructs the start of the printing if the determining unit determines that there is the other printing apparatus having the same name.

### BRIEF DESCRIPTION OF DRAWINGS

FIG. 1 is a block diagram illustrating an electrical configuration of a printer common to first to fourth exemplary embodiments of the present invention;

FIG. 2 is a block diagram schematically illustrating an operation of a printing system common to the first to fourth exemplary embodiments of the present invention;

FIG. 3 is a flow chart illustrating a procedure of a printing process common to the first to third exemplary embodiments of the present invention;

FIG. 4 is a view illustrating an example of a printer list common to the first to fourth exemplary embodiments of the present invention;

FIG. 5 is a flow chart illustrating a procedure of a print-prohibition determining process according to the first exemplary embodiment of the present invention;

FIG. 6 is a flow chart illustrating a procedure of a print-instruction receiving process according to the first exemplary embodiment of the present invention;

FIG. 7 is a flow chart illustrating a procedure of a print-prohibition determining process according to the second exemplary embodiment of the present invention;

FIG. 8 is a flow chart illustrating a procedure of a print-prohibition determining process according to the third exemplary embodiment of the present invention;

FIG. 9 is a flow chart illustrating a procedure of a print-prohibition determining process according to a modification of the present invention; and

FIG. 10 is a flow chart illustrating a procedure of a printing process according to the fourth exemplary embodiment of the present invention.

### DETAILED DESCRIPTION

### First Exemplary Embodiment

Hereinafter, a first exemplary embodiment of a printing apparatus of the present invention will be described with reference to the accompanying drawings. In the present exemplary embodiment, the present invention is applied to a printer having a function of acquiring print target data from a web page and printing the print target data.

[Configuration of Printer]

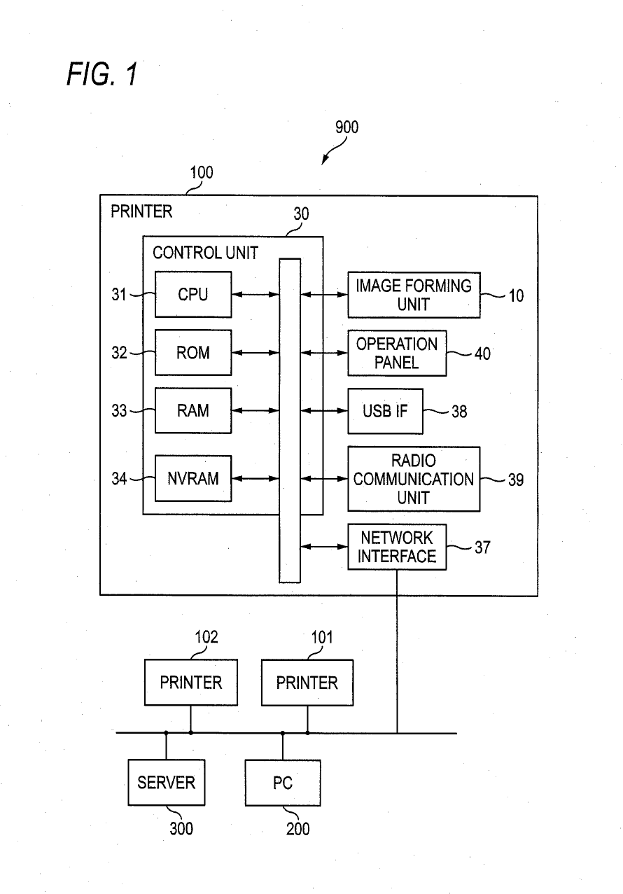

As shown in FIG. 1, a printer 100 (an example of a printing apparatus) of the present exemplary embodiment includes a control unit 30, which includes a CPU 31, a ROM 32, a RAM 33, and a non-volatile RAM (NVRAM) 34. Also, the control unit 30 is electrically connected to an image forming unit 10, an operation panel 40, a network interface 37, a USB interface 38, and a radio communication interface 39. The image forming unit 10 prints images to sheets, and the operation panel 40 displays operation situations and receives user's input operation.

The ROM 32 stores firmware which is control programs for controlling the printer 100, various options, initial values, and so on. The RAM 33 (an example of a storage unit) and the NVRAM 34 (an example of the storage unit) are used as a work area form which various control programs are read or a storage area for temporarily storing print jobs. Also, the NVRAM 34 is used as a storage area for storing various options set after shipment by a user. For example, the NVRAM 34 stores the printer name of the printer and account information.

The CPU 31 (an example of a determining unit or an acquiring unit) controls each component of the printer 100 while storing process results in the RAM 33 or the NVRAM 34 according to control programs read from the ROM 32 and signals transmitted from various sensors.

The network interface 37 and the USB interface 38 enable communication with other apparatuses. The printer 100 uses these interfaces to receive data transmitted from other apparatuses. Also, when receiving print data, the CPU 31 cooperates with the network interface 37 or the USB interface 38, thereby acting as an example of a receiving unit.

In the present exemplary embodiment, the printer 100 is capable of communicating with a personal computer (PC) 200 (an example of an information processing apparatus) having a printer deriver for the printer 100 installed therein, and a management server 300 through the network interface 37. The printer 100 and communication apparatuses such as the PC 200 and the management server 300 configure a printing system 900.

Also, the printer 100 may use other apparatuses through the USB interface 38. For example, in a case where a flash memory (an example of the storage unit) is installed into the USB interface 38, it is possible to use the flash memory as a memory area. Also, in a case where a keyboard is installed into the USB interface 38, it is possible to use the keyboard to perform input operation.

Also, the image forming unit 10 (an example of a printing unit) needs only to print images onto sheets. Therefore, the image forming system of the image forming unit 10 may be an electrophotographic system or an inkjet system. Further, the image forming unit 10 may be capable of color printing, or may be only for monochrome printing.

The operation panel 40 (an example of a display unit) includes various buttons for receiving user's input, and a touch panel screen for displaying text information, buttons, and so on. For example, the various buttons include an ‘OK’ button for instructing start of a printing operation, a ‘CANCEL’ button for instructing cancellation of a printing operation, and letter buttons enabling the user to input the URLs of web pages.

[Configuration of Management Sever]

The management server 300 is for intermediating printing of the printer 100, a printer 101, and a printer 102. The management server 300 is not a server provided by the vendor of the printer 100, the printer 101, and the printer 102, but is a server provided by a company providing cloud printing (hereinafter, referred to as a partner company).

The management server 300 stores printer list 320 in a memory area 310 of the management server 300. The printer list 320 includes a user ID, Authtoken, and a printer name stored in association with one another. The user ID is an ID provided from the partner company, and the Authtoken is identification information assigned to a user when the user uses the user ID to log in to the management server 300.

Also, since the user ID and the Authtoken are associated with each other in the management server, during log-in, if the user ID is received, it is unnecessary to input something with respect to the Authtoken.

[Configuration of Printing System]

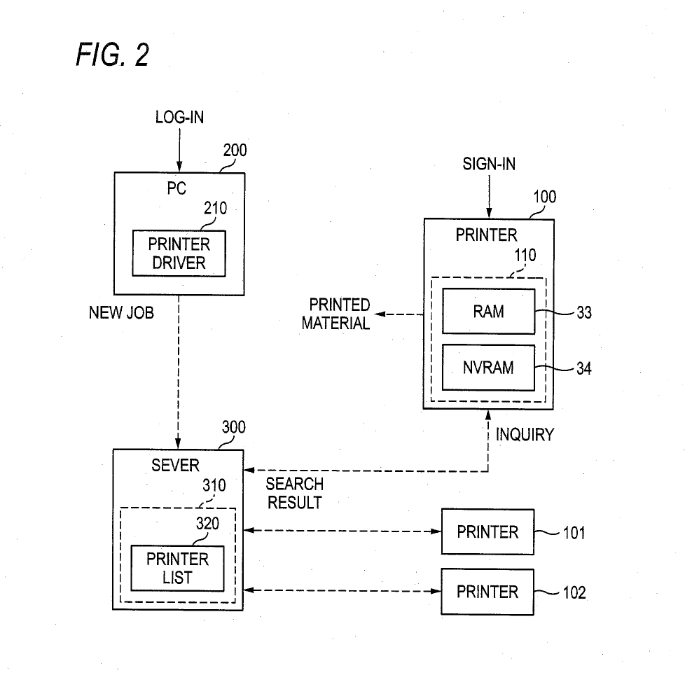

Subsequently, the configuration and operation of the printing system 900 including the printer 100 will be described with reference to FIG. 2.

In the printing system 900, if the PC 200 receives a user ID and account information such as a password, the PC 200 logs in to the management server 300, whereby connection of the PC 200 and the management server 300 is established. Also, similarly to the PC 200, if the printer 100 receives account information, the printer 100 signs in to the management server 300 (an example of ‘connection’), whereby connection of the printer 100 and the management server 300 is established.

Further, the printing system 900 is configured such that if the same account information is used for the PC 200 to log in to the management server 300 and for the printer 100 to sign in to the management server 300, it is possible to designate the printer 100 to perform printing from the PC.

Also, in this specification, for descriptive purposes, account information input of the user from the PC 200 for establishing the connection of the PC 200 and the management server 300 is referred to as log-in, and account information input of the user from the printer 100 for establishing the connection of the printer 100 and the management server 300 is referred to as sign-in.

Also, in this specification, the connection and disconnection of the management server 300 and the printer 100 are not limited to physical connection and disconnection. The connection includes a state where data communication is possible, and the disconnection includes a state where data communication is not possible.

In the printing system 900 shown in FIG. 2, like the printer 100, the printer 101 and the printer 102 use the same account information to sign in to the management server 300. In this case, it is possible to use the PC 200 to designate any one of the printer 100, the printer 101, and the printer 102 to perform printing.

For example, if the PC 200 receives a print instruction for the printer 100 from the user, a printer driver 210 installed in the PC 200 generates a print job. Then, the PC 200 transmits the print job for the printer 100 through the management server 300.

If the print job is transmitted to the printer 100, the printer 100 stores the print job in a memory area 110 secured for storing print jobs. The memory area 110 is configured of at least one of the RAM 33 and the NVRAM 34. Also, in a case where an external memory such as a USB memory or an MD is connected, the memory area 110 may include a memory area secured in the external memory.

After receiving the print job (an example of a print instruction), the printer 100 starts printing of the print job. After inputting the print job to the printer 100, the user goes to a place where the printer 100 is installed. Thus, the user can obtain the printed material. The print instruction may be the print job of the present exemplary embodiment, instruction information for print instruction different from the print job, or the combination of the print job and the instruction information.

However, in the above-mentioned printing procedure, for example, in a case where the printer 100 and the printer 102 has the same printer name, even if the user intends to designate the printer 102 and input the print job to the printer 102, actually, the user may designate the printer 100 and input the print job to the printer 100.

In this case, even if the user goes to a place where the printer 102 is installed, the user cannot obtain the printed material, and the printed material may be left at the printer 100. Therefore, a third party may take or see the printed material, whereby the information of the printed material may leak.

For this reason, after receiving the print job, the printer 100 inquires of the management server 300 about whether there is any other printer with the same name among printers which have the same account information and are in a signed in state to the management server 300.

As a result of the inquiry to the management server 300, if there is any other printer with the same name among printers which have the same account information and are in a signed in state to the management server 300, the printer 100 stores the print job (an example of ‘acquiring’) and then waits for input of a password relative to the print job. In other words, when receiving the print job, the printer 100 does not start printing of the print job. Therefore, it is possible to prevent the printed material from being left at the printer 100. Further, it is possible to prevent information from leaking from the printed material left at the printer 100.

After storing the print job, the printer 100 notifies the management server 300 of the password relative to the print job, and then, the management server 300 notifies the PC 200 of the password. The printer 101 and the printer 102 are configured similarly to the printer 100.

[Control of Printer]

Subsequently, the control of the printer 100 for implementing the above-mentioned operation of the printing system 900 will be described. As described above, the operation of the printer 100 includes the printing process in which a print job becomes a standby state in a case where there is another printer with the same name, and a print reception process of performing printing of the print job in a case where the print job is in the standby state. These two operations will be mainly described hereinafter.

[Printing Process]

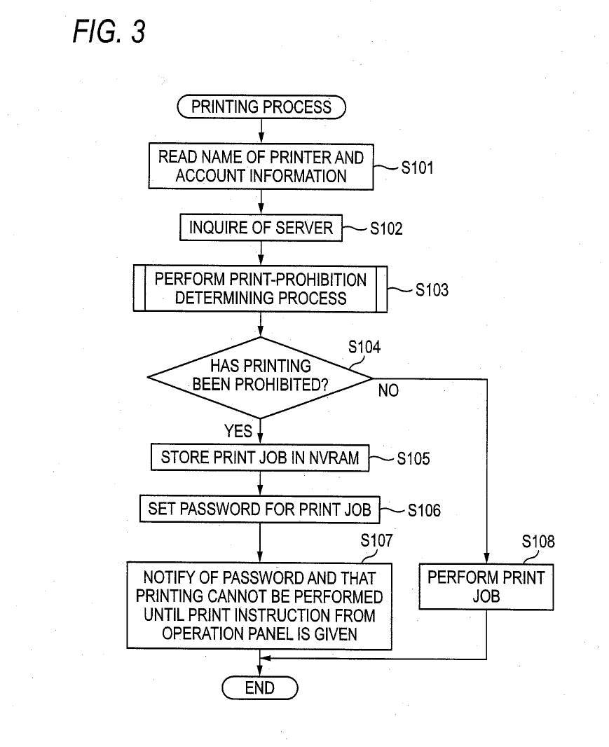

The procedure of the printing process will be described with reference to the flow chart of FIG. 3. The printing process is performed by the CPU 31 in response to the printer 100 receiving a print job. It is assumed that immediately after the reception, the received print job is stored in the RAM 33.

In the printing process, first, in STEP S101, the CPU 31 reads the account information and the printer name of the printer 100 (an example of the name of the printing apparatus) stored in the NVRAM 34.

Next, the CPU 31 transmits the printer name of the printer 100 and the account information to the management server 300. Subsequently, in STEP S102, the CPU 31 inquires of the management server 300 about whether there is any other printer with the same name among printers which have the same account information and are in a signed in state to the management server 300.

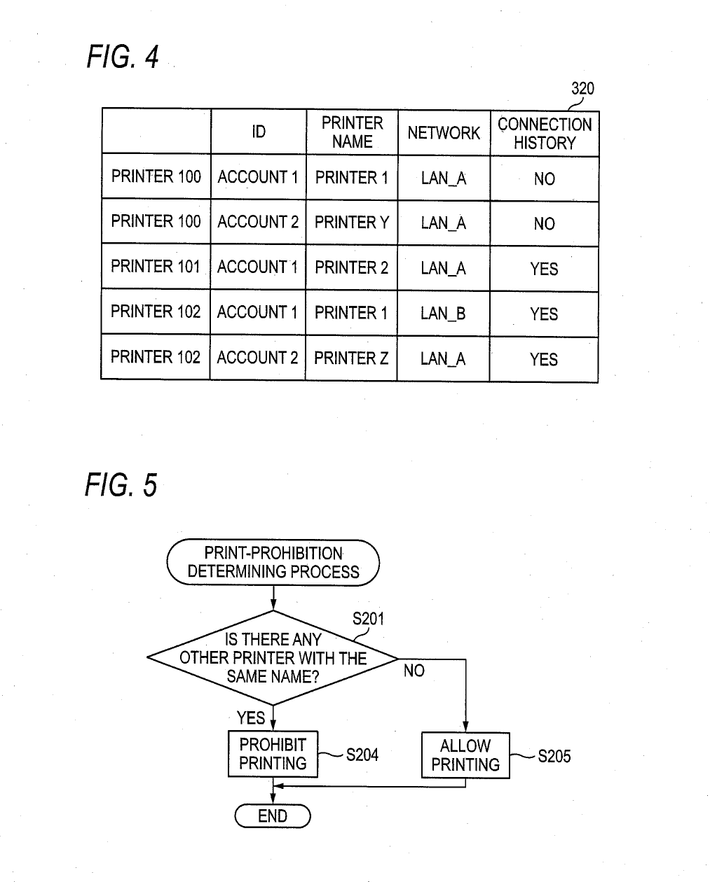

The operation of the management server 300 according to reception of the inquiry will be described. In order to manage the printers which are in the signed in state, the management server 300 has the printer list 320 as shown in FIG. 4 stored in the memory area 310.

First, in a case where the ID of the account information received from the printer 100 is ‘ACCOUNT1’, the management server 300 determines the printer 100, the printer 101, and the printer 102 signed in with ‘ACCOUNT1’ and included in the printer list 320 as an object of search.

Next, the management server 300 searches the printer names of the printers 100, 101, and 102. Among the printers corresponding to ‘ACCOUNT1’, the printer 100 and the printer 102 have the same printer name ‘PRINTER1’ (an example of the same name of the printing apparatus). Therefore, the management server 300 transmits an inquiry result, which indicates that there is another printer with the same name among the printers which have the same account information and are in a signed in state to the management server 300, to the printer 100. The printer names are composed of letters, symbols, and the like such that the user of the PC 200 can identify the printers. For example, the printer names may be model names determined by the makers of the printers, or may be names arbitrarily determined by the user.

Meanwhile, in a case where the ID of the account information received from the printer 100 is ‘ACCOUNT2’, the management server 300 determines the printer 101 and the printer 102 signed in with ‘ACCOUNT2’ and included in the printer list 320 as an object of search.

As shown in FIG. 4, the printer 100 has ‘ACCOUNT1’ and ‘ACCOUNT2’ as the ID of the account information. Although the printer 100 is one printer, when the ID of the account information is ‘ACCOUNT1’, the printer 100 operates in the printer name of ‘PRINTER1’, and when the ID of the account information is ‘ACCOUNT2’, the printer 100 operates in the printer name of ‘PRINTERY’. For example, in a case of using the PC 200 to designate the printer 100 to perform printing, if the user uses the PC 200 to log in to the management server 300 with ‘ACCOUNT1’ and designate ‘PRINTER1’, printing is performed by the printer 100. Alternatively, if the user uses the PC 200 to log in to the management server 300 with ‘ACCOUNT2’ and designate ‘PRINTERY’, printing is performed by the printer 100.

When the ID of the account information is ‘ACCOUNT2’, the printer 100 has the printer name ‘PRINTERY’, and the printer 102 has the printer name ‘PRINTERZ’. That is, the printer names of the printer 100 and the printer 102 are different. Therefore, the management server 300 transmits an inquiry result indicating that there is no other printer with the same name among the printers which have the same account information and are in a signed in state to the management server 300.

In receiving the inquiry result from the management server 300, in STEP S103, the CPU 31 performs a print-prohibition determining process of determining whether to prohibit printing of the received print job on the basis of the inquiry result.

[Print-Prohibition Determining Process]

Now, the procedure of the print-prohibition determining process will be described with reference to FIG. 5. First, in STEP S201, the CPU 31 determines whether there is another printer with the same name among the printers which have the same account information and are in a signed in state to the management server 300, on the basis of the inquiry result from the management server 300 (an example of the determining unit). Specifically, it can be considered a configuration in which in a case where the management server 300 transmits a notification representing that there are the printer 100 and the printer 102 having the printer name ‘PRINTER1’ when the account information is ‘ACCOUNT1’ as the inquiry result to the printer 100, the CPU 31 determines whether there is another printer with the same name on the basis of the number of printers in the inquiry result. Alternatively, it can be considered a configuration in which in the case where the management server 300 transmits a notification of a determination result representing that there is another printer with the same name as the inquiry result to the printer 100, the CPU 31 determines whether there is another printer with the same name on the basis of the notification of the determination result from the management server 300.

In a case of determining that there is another printer with the same name among the printers which have the same account information and are in a signed in state to the management server 300 (YES in STEP S201), the CPU 31 prohibits printing in STEP S204 (an example of a print prohibiting unit) and terminates the print-prohibition determining process.

Meanwhile, in a case of determining that there is no other printer with the same name among the printers which have the same account information and are in a signed in state to the management server 300 (NO in STEP S201), the CPU 31 allows printing in STEP S205 and terminates the print-prohibition determining process.

Returning to the flow chart of FIG. 3, after the print-prohibition determining process of STEP S103, in STEP S104, the CPU 31 determines whether printing has been prohibited. In a case of determining that printing has been prohibited (YES in STEP S104), in STEP S105, the CPU 31 stores the print job stored in the RAM 33, in the NVRAM 34 (an example of the acquiring unit of claims). In other words, the CPU 31 moves the print job from the RAM 33 to the NVRAM 34. Next, in STEP S106, the CPU 31 sets a password for performing printing of the print job stored in the NVRAM 34.

Next, in STEP S107, the CPU 31 notifies the PC 200 of the set password and that printing cannot be performed until a print instruction is entered from the operation panel 40 (an example of a notifying unit). Then, the CPU 31 terminates the printing process.

Meanwhile, in a case of determining that printing has been allowed (NO in STEP S104), the CPU 31 performs the print job in STEP S108, and terminates the printing process.

[Print-Instruction Receiving Process]

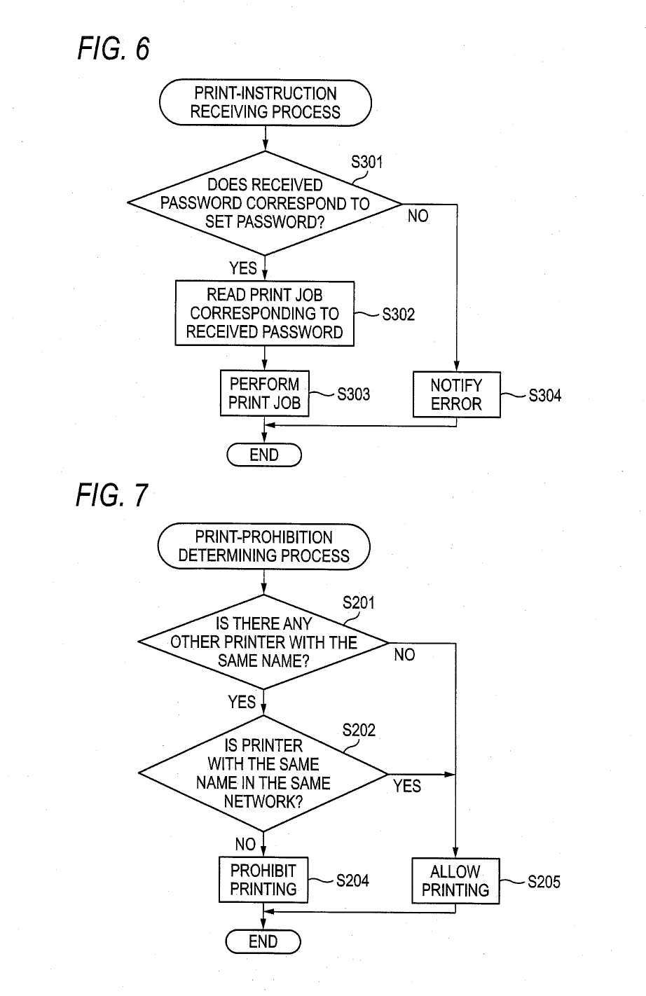

Subsequently, the procedure of a print-instruction receiving process will be described with reference to the flow chart of FIG. 6. In a case where the CPU 31 becomes the standby state in which the CPU 31 waits for input of a password relative to the print job in the printing process (see paragraph [0041]), the print-instruction receiving process is performed in response to receiving input of a password.

First, in STEP S301, the CPU 31 determines whether the received password corresponds to the password set in STEP S106.

In a case of determining that the received password corresponds to the password set in STEP S106 (YES in STEP S301), in STEP S302, the CPU 31 reads the print job corresponding to the received password. Then, the CPU 31 performs the print job in STEP S303, and terminates the print-instruction receiving process.

Meanwhile, in a case of determining that the received password does not correspond to the password set in STEP S106 (NO in STEP S301), in STEP S304, the CPU 31 displays an error message representing that the received password does not correspond to the password set in STEP S106. Then, the CPU 31 terminates the print-instruction receiving process.

### Effects of First Exemplary Embodiment

As described above in detail, in the printing apparatus according to the first exemplary embodiment, in a case of determining that there is a printer with the same name among the printers which have the same account information and are in a signed in state to the management server 300 (YES in STEP S201), in STEP S204, the CPU 31 prohibits printing. Specifically, in STEP S105, the CPU 31 stores the print job stored in the RAM 33, in the NVRAM 34. Next, in STEP S106, the CPU 31 sets a password for performing printing of the print job stored in the NVRAM 34. In this way, the prohibition of printing is performed. In other words, even if the print job is received, printing cannot be performed unless the user performs an operation such as input of a password. Therefore, even if there is a plurality of printers with the same name, it is possible to prevent printing from being performed in a printer unintended by the user, and to prevent the printed material from being left at an unintended printer.

Also, the management server 300 has the printer list 320 as shown in FIG. 4 stored in the memory area 310 for managing the printers which are in the signed in state, searches the printer list 320, and transmits the inquiry result to the printer 100. Therefore, the printers to be searched are limited to the printers connected to the management server 300. As a result, it is possible to improve the efficiency of the searching.

Also, in the case where the ID of the account information received from the printer 100 is ‘ACCOUNT1’, the management server 300 determines, as the object of search, the printer 100, the printer 101, and the printer 102 signed in with ‘ACCOUNT1’ and included in the printer list 320. Meanwhile, in a case where the ID of the account information received from the printer 100 is ‘ACCOUNT2’, the management server 300 determines, as the object of search, the printer 101 and the printer 102 signed in with ‘ACCOUNT2’ and included in the printer list 320. Therefore, the range of printers to be searched is limited to the printer signed in with the same account information as the account information stored in the NVRAM 34. Therefore, it is possible to improve the efficiency of the searching.

Also, in STEP S107, the CPU 31 notifies the PC 200 of the set password and that printing cannot be performed until a print instruction from the operation panel 40 is entered. Therefore, the user can know that the printing is prohibited although the printer 100 has received the print job.

### Second Exemplary Embodiment

In the first exemplary embodiment, in the print-prohibition determining process, it is determined whether there is another printer with the same name However, in a second exemplary embodiment shown in FIG. 7, it is also determined whether the printer with the same name is on the same network. Some of the processes similar to those in the first exemplary embodiment may not be described.

[Print-Prohibition Determining Process]

In FIG. 7, in the case of determining that there is a printer with the same name among the printers which have the same account information and are in a signed in state to the management server 300 (YES in STEP S201), in STEP S202, the CPU 31 determines whether the printer with the same name is on the same network.

Here, on the same network means, for example, on the same LAN. It can be considered that on the same LAN, computers, communication devices, printers, and the like form network in a wired or wireless manner, and print jobs and the like may be exchanged. Even if the printed material is left at the printer 100, it is likely that the contents of the printed material are contents already shared by users on the same LAN or contents that the users on the same LAN can easily guess from contents that the users on the same LAN already know. In this case, it can be considered that the possibility of information leaking from the printed material left at the printer 100 to third parties whom it is not intended to share the information with is low.

In a case of determining that the printer with the same name is on the same network (YES in STEP S202), the CPU 31 allows printing in STEP S205 and terminates the print-prohibition determining process.

Meanwhile, in a case of determining that the printer with the same name is not on the same network (NO in STEP S202), the CPU 31 prohibits printing in STEP S204 (an example of the print prohibiting unit) and terminates the print-prohibition determining process. The prohibition of printing is performed because if the printer with the same name is not on the same network, information is still likely to leak.

Specifically, as shown in FIG. 4, when the ID of the account information is ‘ACCOUNT1’, the printer 100 has the same printer name ‘PRINTER1’ as the printer name of the printer 102. Also, the network of the printer 100 is ‘LAN_A’, whereas the network of the printer 102 is ‘LAN_B’. Therefore, the networks of the printer 100 and the printer 102 are different from each other. As a result, printing is prohibited in the printer 100.

### Effects of Second Exemplary Embodiment

As described above in detail, in a printing apparatus according to the second exemplary embodiment, in the case of determining that the printer with the same name is on the same network (YES in STEP S202), in STEP S205, the CPU 31 allows printing. By allowing printing in a case where there is a printer having the same name but is on the same network, it is possible to reduce the effort of the user for input of a password or the like in the print-instruction receiving process. As a result, it is possible to improve the user convenience while reducing a possibility that information will leak from the printed material.

### Third Exemplary Embodiment

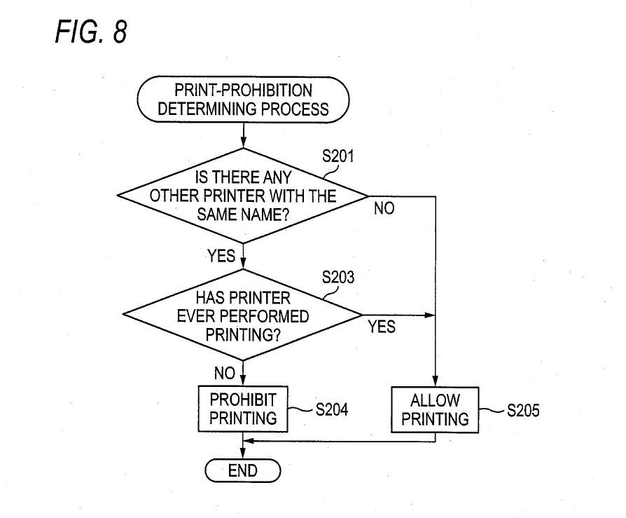

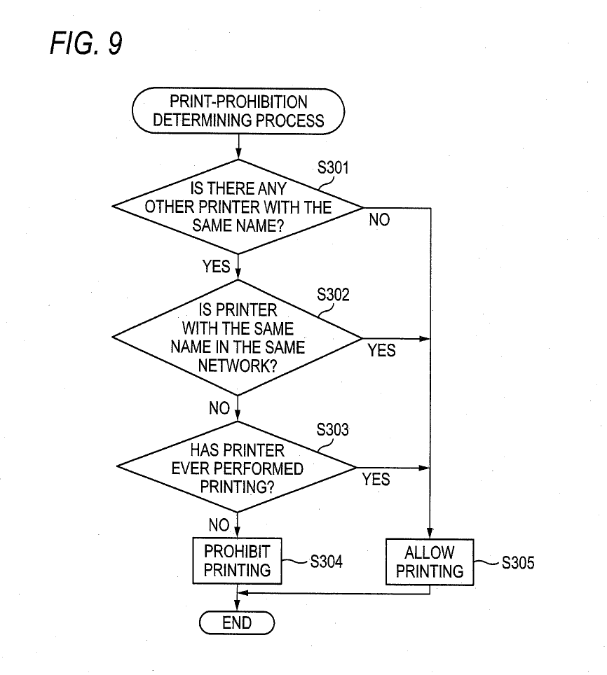

In the first exemplary embodiment, in the print-prohibition determining process, it is determined that there is another printer with the same name However, in a third exemplary embodiment shown in FIG. 8, it is also determined whether printing has been performed by the printer 100 before. Also, the second exemplary embodiment and the third exemplary embodiment may be combined to configure an embodiment as shown in FIG. 9. Some of the similar processes as those of the first exemplary embodiment and the second exemplary embodiment may not be described.

[Print-Prohibition Determining Process]

In FIG. 8, in a case of determining that there is a printer with the same name among the printers which have the same account information and are in a signed in state to the management server 300 (YES in STEP S201), in STEP S203, the CPU 31 determines whether printing has been performed by the printer 100 before. Here, the determination of STEP S203 is performed by determining whether the printer 100 has been connected to the management server 300 before during the inquiring of the management server 300 in STEP S102. Alternatively, it may be determined whether the printer 100 has actually performed printing before.

In a case of determining that the printer 100 has never performed printing before (NO in STEP S203), the CPU 31 prohibits printing in STEP S204 (an example of the print prohibiting unit) and terminates the print-prohibition determining process.

Specifically, as shown in FIG. 4, when the ID of the account information is ‘ACCOUNT1’, the printer 100 has the same printer name ‘PRINTER1’ as the printer name of the printer 102. Further, the print history of the printer 100 is ‘NO’. Therefore, in the printer 100, printing is prohibited.

Meanwhile, in a case of determining that the printer 100 has performed printing before (YES in STEP S203), the CPU 31 allows printing in STEP S205 and terminates the print-prohibition determining process.

For example, even in the case where there is another printer with the same name, if the printer 100 has been connected to the management server 300 before, the user of the PC 200 intending to give a print instruction may know a place where a printer with the same name at the upper side of a pull-down menu for printer selection is installed and a place where another printer with the same name at the lower side of the pull-down menu is installed. In this case, it is likely that the user knows the place where the printer 100 is installed. Therefore, it can be considered that a possibility that the printed material will be left at the printer 100 is low.

### Effects of Third Exemplary Embodiment

As described above in detail, in the printing apparatus according to the third exemplary embodiment, in the case of determining that printing has been performed by the printer 100 before (YES in STEP S203), the CPU 31 allows printing in STEP S205. Since it is likely that the user knows the position of the printer 100, it can be considered that a possibility that the printed material will be left at the printer 100 is low. Also, even in a case where there is another printer with the same name, if the printer 100 has performed printing before, printing is allowed. Therefore, it is possible to reduce the effort of the user for password input or the like in the print-instruction receiving process. As a result, it is possible to improve the user convenience while reducing a possibility that information will leak from the printed material.

### Fourth Exemplary Embodiment

In the first to third exemplary embodiments, the printer 100 receives the print job, and then starts printing relative to the print job. However, in the fourth exemplary embodiment, it is assumed that if a notification indicating that the management server 300 stores a print job (an example of a print instruction) is received, the printer 100 acquires the print job from the management server 300 and performs the acquired print job.

In the case where there is another printer with the same name, the printer 100 prohibits acquisition of print jobs from the management server 300. Therefore, it is possible to prevent the printed material from being left at the printer 100. The print-prohibition determining process and the print-instruction receiving process are the same as those of the first to third exemplary embodiments.

[Printing Process]

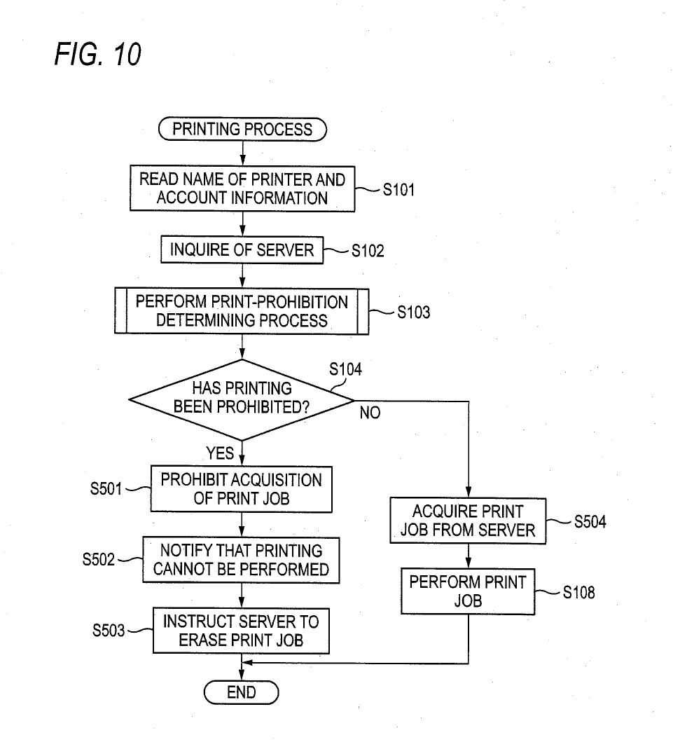

The procedure of a printing process will be described with reference to the flow chart of FIG. 10. If the printer 100 receives a notification indicating that the management server 300 stores a print job from the management server 300, the printing process is performed by the CPU 31.

In the printing process, STEPS S101 to S104 are the same as those of the first to third exemplary embodiments, and STEPS subsequent to STEP S104 are different from those of the first to third exemplary embodiments. Therefore, STEPS subsequent to STEP S104 will be described in more detail.

In the case of determining that printing has been prohibited (YES in STEP S104), in STEP S501, the CPU 31 prohibits acquisition of the print job from the management server 300 (an example of an acquisition prohibiting unit). Then, in STEP S502, the CPU 31 notifies the PC 200 that printing cannot be performed through the management server 300.

Next, the CPU 31 instructs the management server 300 to erase the print job in STEP S503, and terminates the printing process. This is because unless the print job is erased, the print job may be stored in the management server 300 eternally so as to occupy a large part of the memory area 310 of the management server 300.

Meanwhile, in the case of determining that printing has been allowed (NO in STEP S104), in STEP S504, the CPU 31 acquires the print job from the management server 300 (an example of the acquiring unit). Then, the CPU 31 performs the print job in STEP S108, and terminates the printing process.

### Effects of Fourth Exemplary Embodiment

As described above in detail, in the printing apparatus of the fourth exemplary embodiment, in case of determining that printing has been prohibited (YES in STEP S104), in STEP S501, the CPU 31 prohibits acquisition of the print job from the management server 300. Therefore, even if there is a plurality of printers with the same name, it is possible to prevent printing from being performed in a printer unintended by the user, and to prevent a printed material from being left at an unintended printer.

[Modifications]

The embodiments are merely illustrative and do not limit the present invention. Therefore, needless to say, the present invention can be improved and modified within a scope which does not diverge from the gist. For example, the printer needs only to have the printing function, and thus the present invention can be applied to a multi-functional apparatus or a copy machine.

Also, in the above-mentioned embodiments, the management server 300 is connected to an Internet line. However, the present invention is not limited thereto. For example, the management server 300 may be connected to a network such as a WAN or a LAN.

Also, in the above-mentioned embodiments, the printer 100 inquires of the management server 300, such that the management server 300 searches printers which have the same account information and are in the singed in state to the management server 300 to determine whether there is another printer with the same name. However, the present invention is not limited thereto. For example, the printer 100 may download the printer list 320 stored in the management server 300, and determine whether there is another printer with the same name among the printers which have the same account information and are in the singed in state to the management server 300. Also, the printer 100 may regularly download the printer list 320, thereby regularly updating the printer list 320.

Also, in the above-mentioned embodiments, the printer 100 stores the print job in the RAM 33 and then copies the print job stored in the RAM 33 into the NVRAM 34. However, the present invention is not limited thereto. For example, the printer 100 may store the print job directly in the NVRAM 34, not through the RAM 33. Also, instead of the NVRAM 34, a non-volatile memory such as a flash ROM may be used.

Also, in the above-mentioned embodiments, the user operates the operation panel 40 to input a password, thereby starting printing of a print job stored in the printer. However, the present invention is not limited thereto. For example, printing may start in response to a print instruction from a mobile terminal or authentication using a card reader or the like.

Also, in the above-mentioned embodiments, the management server 300 is a server provided by the partner company. However, the present invention is not limited thereto. For example, a server provided by a vendor may be used, or a server provided by the partner company and a server provided by a vendor may be used collaboratively.

Also, in the above-mentioned embodiments, in a case where multiple printers belong to the same LAN, it is determined that the printers are on the same network. However, the present invention is not limited thereto. The LAN may be replaced by a WAN. Also, if multiple printers are in a same department of a company or in a same classroom of a school, the printers can be considered as being on the same network.

What is claimed is:

1. A printing apparatus having a name, the printing apparatus comprising:
a connecting unit connected to a management server;
a receiving unit configured to receive a print instruction from the management server;
a determining unit configured to determine whether there is another printing apparatus having a same name as the name of the printing apparatus among a printing apparatus connected to the management server in response to receiving the print instruction;
an acquiring unit configured to acquire a print job that is instructed to be printed;
a printing unit configured to perform printing relative to the print job acquired by the acquiring unit;
an instructing unit configured to instruct start of the printing relative to the print job; and
a print prohibiting unit configured to prohibit the printing relative to the print job acquired by the acquiring unit from being performed until the instructing unit instructs the start of the printing if the determining unit determines that there is the other printing apparatus having the same name

2. The printing apparatus according to claim 1,
wherein the print prohibiting unit does not prohibit the printing if the other printing apparatus with the same name is on the same network as the printing apparatus.

3. The printing apparatus according to claim 1,
wherein the print prohibiting unit prohibits the printing if the other printing apparatus with the same name is not on the same network as the printing apparatus.

4. The printing apparatus according to claim 1,
wherein the print prohibiting unit does not prohibit the printing if printing has been performed by the printing apparatus before.

5. The printing apparatus according to claim 1,
wherein the print prohibiting unit prohibits the printing if printing has never been performed by the printing apparatus before.

6. The printing apparatus according to claim 1,
wherein the determining unit determines whether there is the other printing apparatus with the same name from a printing apparatus connected to the management server.

7. The printing apparatus according to claim 1, further comprising:
a storage unit configured to store account information,
wherein the determining unit determines whether there is the other printing apparatus with the same name from a printing apparatus having a same account as an account indicated by the account information stored in the storage unit.

8. The printing apparatus according to claim 1, further comprising:
a notifying unit configured to notify that printing is prohibited if the print prohibiting unit prohibits printing.

9. The printing apparatus according to claim 1, further comprising:
a setting unit configured to set authentication information to the acquired print job.

10. The printing apparatus according to claim 9,
wherein the instruction unit instructs the start of the printing relative to the print job in response to receiving authentication information that corresponds to the authentication information that is set to the acquired print job.

11. A printing apparatus having a name, the printing apparatus comprising:
a connecting unit connected to a management server;
a receiving unit configured to receive a print instruction from the management server;
a determining unit configured to determine whether there is another printing apparatus having a same name as the name of the printing apparatus in response to receiving the print instruction;
an acquiring unit configured to acquire a print job that is instructed to be printed;
a printing unit configured to perform printing relative to the print job acquired by the acquiring unit;
an instructing unit configured to instruct start of the printing relative to the print job; and
an acquisition prohibiting unit configured to prohibit the acquiring unit from acquiring the print job until the instructing unit instructs the start of the printing if the determining unit determines that there is the other printing apparatus having the same name.

12. The printing apparatus according to claim 11,
wherein the acquiring unit acquires the print job from the management server.

13. A printing system including a management server including a transmitting unit configured to transmit a print instruction and a printing apparatus having a name and including a receiving unit configured to receive the print instruction from the management server and a printing unit configured to perform printing relative to a print job, the management server and the printing apparatus being connected to a network, the printing system comprising:
a determining unit configured to determine whether there is another printing apparatus having a same name as the name of the printing apparatus in response to receiving the print instruction;
an acquiring unit configured to acquire the print job that is instructed to be printed;
an instructing unit configured to instruct start of the printing relative to the print job; and
a print prohibiting unit configured to prohibit the printing relative to the print job acquired by the acquiring unit from being performed until the instructing unit instructs the start of the printing if the determining unit determines that there is the other printing apparatus having the same name.

14. A printing system in which a management server including a transmitting unit configured to transmit a print instruction and a printing apparatus having a name and including a receiving unit configured to receive the print instruction from the management server and a printing unit configured to perform printing relative to a print job, the management server and the printing apparatus being connected to a network, the printing system comprising:
a determining unit configured to determine whether there is another printing apparatus having a same name as the name of the printing apparatus in response to receiving the print instruction;
an acquiring unit configured to acquire the print job that is instructed to be printed;
an instructing unit configured to instruct start of the printing relative to the print job; and
an acquisition prohibiting unit configured to prohibit the acquiring unit from acquiring the print job until the instructing unit instructs the start of the printing if the determining unit determines that there is the other printing apparatus having the same name.
